(19) United States
(12) Patent Application Publication
(10) Pub. No.: US 2017/0064492 A1
(43) Pub. Date: Mar. 2, 2017

(54) EXPEDITED ROBUST PEER-TO-PEER CONNECTION

(71) Applicant: INTEL IP CORPORATION, Santa Clara, CA (US)

(72) Inventors: Emily H. Qi, Portland, OR (US); Elad Oren, Tel Aviv (IL); Po-Kai Huang, West Lafayette, IN (US); Dibakar Das, Hilsboro, OR (US)

(21) Appl. No.: 14/837,180

(22) Filed: Aug. 27, 2015

(51) Int. Cl. H04W 4/00; H04L 29/08; H04W 4/06; H04W 8/00

(52) U.S. Cl. CPC H04W 4/008; H04W 8/005; H04L 67/104; H04W 4/06; H04W 84/12

(57) ABSTRACT

System and techniques for expedited robust peer-to-peer connections are described herein. A station (STA) transceiver may be enabled during a common window for a wireless network based on a synchronized timing for the network. A neighbor awareness networking (NAN) service discovery frame may be constructed for a service. The NAN service discovery frame may include an expedited robust connection data structure, which may include a robust connection request and capability data. The constructed NAN service discovery frame may be broadcast during the common window via the transceiver.

### TECHNICAL FIELD

Embodiments described herein generally relate to wireless peer-to-peer networking more specifically to expedited robust peer-to-peer connections.

### BACKGROUND

Wireless networking, such as a wireless local area network (WLAN) operating in accordance with the IEEE 802.11 family of standards, often includes a variety of physical and application layer connectivity options. Such options can include what radio frequency (RF) channel to use, security keys of the participants, etc. Neighborhood Aware Networking (NAN) operates as a facilitator in low power wireless communications between devices. NAN provides a mechanism whereby participants synchronize a window in which participants are awake to communicate services offered by the various participants as well as negotiate use of those services by service consumers. peer-to-peer networking using those services occurs outside of the NAN specification.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A and 1B illustrate an example of an environment for expedited robust peer-to-peer connection using NAN, according to an embodiment.

FIG. 2 illustrates a block diagram of an example of a wireless device to implement expedited robust peer-to-peer connection in a NAN environment, according to an embodiment.

FIG. 3 illustrates an example of a data structure definition for a robust connection data structure in a NAN service discovery frame, according to an embodiment.

FIG. 4 illustrates an example of a robust connection data structure, according to an embodiment.

FIGS. 5 and 6 are swim-lane diagrams of performing expedited robust peer-to-peer connection in a NAN environment, according to two embodiments.

FIG. 7 illustrates a flow diagram of an example of a method for expedited robust peer-to-peer connection in a NAN environment, according to an embodiment.

FIG. 8 illustrates a flow diagram of an example of a method for selecting capabilities of a service to include in a robust connection data structure, according to an embodiment.

FIG. 9 illustrates a flow diagram of an example of a method for communicating with a second machine using the robust connection after the transference of the robust connection data structure in a NAN service discovery frame, according to an embodiment.

FIG. 10 is a block diagram illustrating an example of a machine upon which one or more embodiments may be implemented.

### DETAILED DESCRIPTION

NANs typically assist in low power ad-hoc networks by providing a mechanism for several devices to synchronize a discovery window. By synchronizing this window, devices can sleep outside of the window, conserving power, while ensuring that they are awake during service discovery. NANs also provide a mechanism for these device to advertise what services they offer, such as routing services, local based services, etc. NANs may be implemented in a variety of ways, including, for example, via the Wi-Fi Aware, Wi-Fi Aware 2, and NAN 2.0 SIG standards and subsequent standards, among others.

As noted above, wireless networks may include a variety of physical layer, media layer, or application layer options for two devices to communicate with each other. Such options may include symbol encoding, aggregated frames capability, channels to use, security settings, etc. Because NAN does not specify the manner in which the advertised services are delivered, two devices typically must negotiate wireless network options after the service discovery mechanism takes place. This negotiation may include several messages being passed back and forth between a first device and a second device to settle on the wireless network options that will be used in a communication session. These additional messages may occur in NAN messaging subsequent to the service discovery or in the non-NAN communication following service discovery.

NANs effect on power saving may be reduced by the messaging required to negotiate the wireless connection because the device consumes power in these transmissions without accomplishing useful work to provide or receive the service. Thus, reducing the number of messages passed in the NAN component of a NAN assisted wireless communication may increase the power efficiency of devices using NAN. To reduce these messages, NAN service discovery frames may be augmented with a variety of connection details for a robust connection to a service provider device by a service consuming device. The consuming device may then establish the robust connection to the service providing device without additional messaging by using the data structures encoded in the NAN service discovery frame.

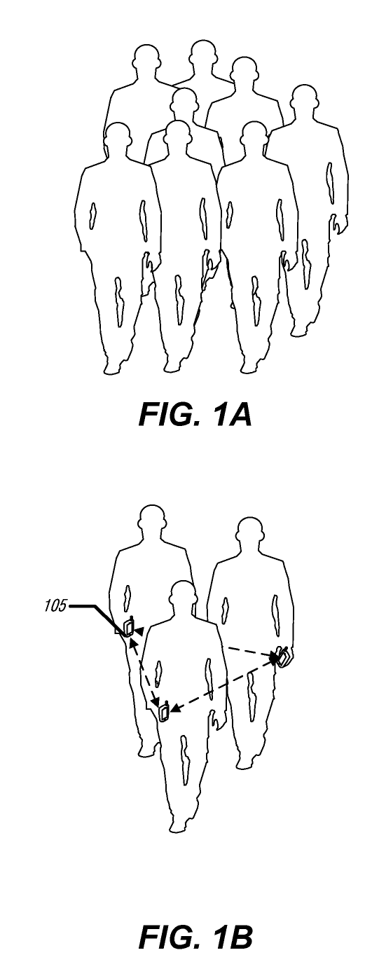

FIGS. 1A and 1B illustrate an example of an environment 100 for expedited robust peer-to-peer connection using NAN, according to an embodiment. The environment 100 is illustrative of one in which NAN may be used. Specifically, the environment 100 includes a group of people in physical proximity to each other, such as at a meeting, conference, concert, or other event, as illustrated in FIG. 1A. FIG. 1B illustrates a subset of the group of people who have NAN wireless devices (e.g., the device 105) communicating with each other. As previously noted, the NAN devices may provide various services to each other. NAN governs the discovery of these services via a common communications window and a service discovery protocol.

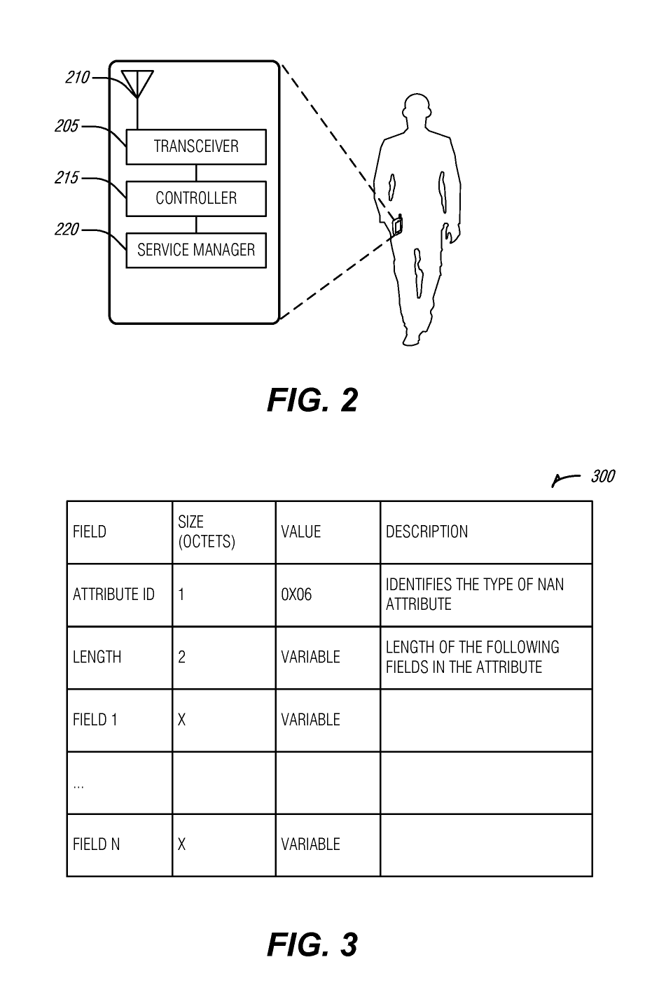

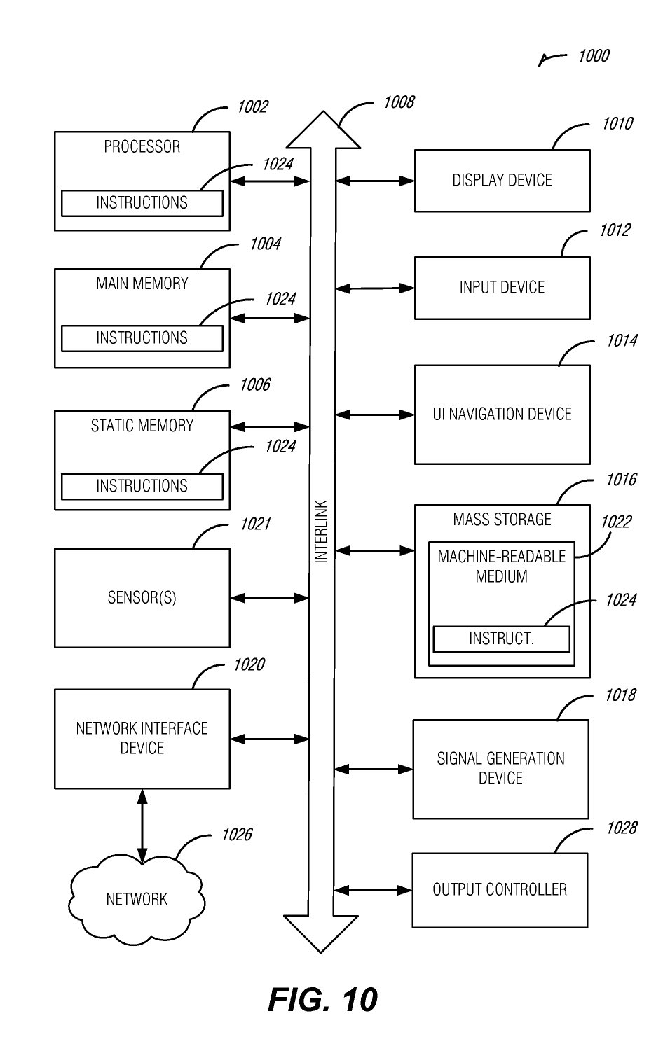

FIG. 2 illustrates a block diagram of an example of a wireless device 200 to implement expedited robust peer-to-peer connection in a NAN environment, according to an embodiment. Here, the device 200 is like the device 105 from FIG. 1B. The device 200 may include a transceiver 205 (or parts of a transceiver such as the antenna 210, encoder, etc.) with an antenna 210, a controller 215, and a service manager 220. Each of these components is implemented in hardware when in operation, such as that described below with respect to FIG. 10 (e.g., via circuit sets).

The service manager 220 may be arranged to construct a NAN service discovery frame for a service. The NAN service discovery frame may include an expedited robust connection data structure. The expedited robust data structure may include a request for a robust connection for the service. As used herein, the request for the robust connection is a request that a consumer of the service use the robust connection to get the service, rather than a request for a service by another device. Further, as used herein, a robust connection is one suited for the service. For example, a low-power connection, such as a personal area network (PAN) may be unsuitable for streaming video content. If the service provides streamed video content, the robust connection may be a WLAN instead of a PAN. However, the appropriateness of a particular connection is up to the discretion of the service providing device, such as the device 200.

The expedited robust data structure may also include a service capability data structure. The service capability data structure may include a plurality of communications capabilities of the device 200 that correspond to the service and the robust connection. For example, if the robust connection refers to a WLAN connection, the capability data structure may include RF channel data to use for the service. However, if the robust connection uses a cellular connection, the capability data may include a service provider and bearer to use for the robust connection.

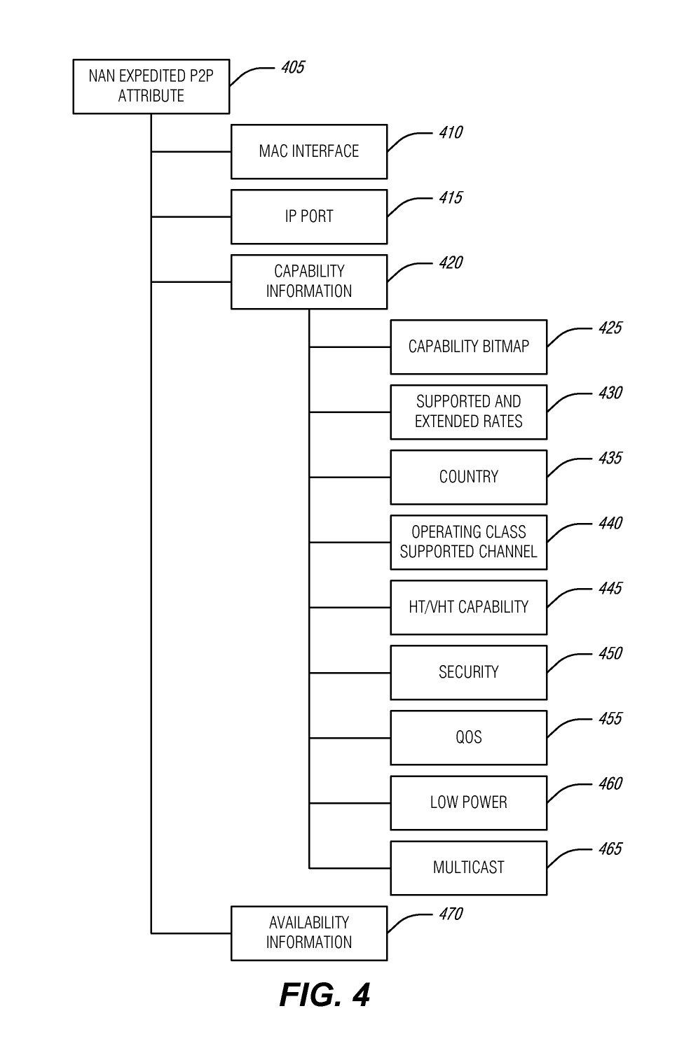

In an example, the request for the robust connection may be a service descriptor attribute in the NAN discovery frame. In an example, the request for the robust connection may be a NAN connection capability attribute of the NAN service discovery frame. In an example, the service capability data structure may be a set of fields in the request for the robust connection. For example, the request for robust connection may comprise a plurality of fields of an attribute in the NAN service discovery frame. A subset of this plurality of fields is designated to the capability data structure. In an example, the request for the robust connection may include an attribute identification (ID) field, a length field, and a non-empty set of additional fields. In this example, the attribute ID specifies that this attribute corresponds to expedited robust connection capability. Thus, a receiver may immediately determine if the device 200 supports expedited robust connections via the attribute ID alone. Also in this example, the length field may define the size of additional fields. Actually identifying which additional field is addressed may be determined via multiplying a field index by the length field value and adding the result to an offset from the beginning of the service discovery frame. In an example, the set of additional fields may include a media access control (MAC) interface address for the service. In this example, the MAC address allows the device 200 to specify an interface other than that used by the device to participate in the NAN. In an example, the additional fields may include a network protocol address or port for the service. In an example, the network protocol conforms to the internet protocol version 6 (IPv6) standard. Thus, these two parameters allow the request for the robust connection to connection to the interface providing the service as well as a particular logical port on that interface. Further details about the additional fields are described below with respect to the data structure 400 of FIG. 4. Generally, however, the request for the robust connection includes the specifics of using the service while the service capability data structure relates to communication capabilities of the device 200 itself.

The transceiver 205 may be arranged to communicate according to one or more wireless standards. The transceiver 205 may include hardware and software to implement physical, media access, or application layer networking according to the standards. The transceiver 205 may also be arranged to be in a plurality of power states, including a low-power mode. In the lower-power mode, the transceiver 205 functions at reduced capacity with respect to wireless communications, including, for example, being unable to transmit data or, in another example, receive data.

The controller 215 may be arranged to enable the transceiver 205 during a common window for a wireless network, such as a NAN. The common window may be defined by a standard and a synchronized timing for the network. For example, the network may provide a mechanism by which several devices in proximity to each other advertise their timing. The network may provide a mechanism by which these device converge on a common time, without being externally synchronized (e.g., from a common time server or network server). The network may then include a common window definition based on time, which at this point is synchronized between the various participants. In this manner, the devices only need to power their transceivers during the common window, saving power otherwise.

The controller 215 may also be arranged to control the transceiver 205 to broadcast the NAN service discovery request, created by the service manager 220, during the common window using the transceiver 205. Through this broadcast, the controller 220 gives other devices access to the services offered by the device 200, as well as the mechanism by which those services are accessed without additional signaling overhead. Thus, in an example, the NAN service discovery frame is the only frame sent by the device 200 with respect to the service, the robust connection, and the common window, excluding simple acknowledgements. As used herein, simple acknowledgments represent communications that are in response to a previous message and do not deal with the contents of the previous message, but rather with logistical issues in sending messages. Accordingly, such acknowledgments include, acknowledging that a packet, data unit, frame, etc. arrived in tact, a retransmission request, etc. By excluding these acknowledgments, the NAN service discovery frame with the request for the robust connection and the service capability data structure operates as a one-way communication from the service provider to the service consumer.

In an example, the controller 215 may be arranged to receive a second NAN service discovery frame from a second device (e.g., machine) during the common window. The second NAN service discovery frame is thus simply from another service provider. In this example, the second service discovery frame includes a second robust connection data structure. In this example, the service manager 220 may be arranged to intersect capability specifications from the second expedited robust connection data structure with those of the device 200 to create a compatible set of capability specifications. The service manager 220 may then populate fields of the expedited robust connection data structure with members of the compatible set of capability specifications. Thus, the device 200 may select robust connection parameters that are both preferred by the device 200 and known to be compatible with the second device.

In an example, the controller 215 may be arranged to receive a robust connection from another device in the NAN, where the robust connection conforms to the parameters defined in the robust connection data structure. In this example, the controller 215 may then participate in the robust connection to deliver the service to the other device. Thus, the expedited robust connection is realized without the additional signaling overhead (and loss of energy) present in other NAN service delivery techniques.

FIG. 3 illustrates an example of a data structure definition 300 for a robust connection data structure in a NAN service discovery frame, according to an embodiment. The data structure definition 300 describes an attribute based example of fixed length fields that may be used to communicate the robust connection request and the capability data structure described above with respect to FIG. 2. As illustrated, the offset from the beginning of the attribute is three octets (e.g., bytes) before the first additional field (e.g., index zero). Accordingly, to index the third additional field, the device 200 would multiply the value of the length field by two (in a zero based index) and add it to three. The device 200 would then read, from this position, a number of octets equal to the length field value to retrieve the data for that additional field.

FIG. 4 illustrates an example of a robust connection data structure 400, according to an embodiment. As illustrated, the data structure 400 is a NAN service discovery frame attribute (e.g., as shown in FIG. 3), with an attribute ID 405 of “NAN expedited data connection.” The data structure 400 may be arranged hierarchically, as shown, or linearly. In an example, the hierarchy may be maintained in a linear data structure by embedding child elements into a field corresponding to the parent. In an example, the hierarchy may be flattened into a linear representation. For example, each of the fields, be they a leaf node or not, may be mapped to a field in a linear data structure, such as the attribute definition 200.

The illustrated fields of the data structure 400 may have the following characteristics:

Field 405: Attribute ID may be used to easily identify the expedited robust connection capability of a device.

Field 410: MAC interface address identifies the MAC interface to be used for the service. This field may be optional where the service will be delivered on the same interface used to transmit the NAN service discovery frame.

Field 415: IP port identifies the network layer parameters for the service.

Field 420: Capability information is optional and provides a variety of information regarding the communications capabilities of the hardware and software providing the service. The capability information field 420 is a parent to the fields 425-465. However, as described above, these child fields may not be stored in the data space allotted to the capability information field 420 itself.

Field 425: The capability bitmap field is a bitmap data structure storing the capability parameters in a raster format. In an example, each pixel and pixel value may be mapped to a predetermined catalog of capabilities, such as physical, media, network, transport, or application layer parameters, timing parameters, etc.

Field 430: The rates field provides the supported or extended data rates support by the device.

Field 435: The country field indicates the country of the device. This field 435 may be optional when the NAN service discovery frame includes a country attribute.

Field 440: The operating class and supported channel field for the device. This field 440 may be optional if the NAN service discovery frame includes a resource constraint attribute. In an example, this field 440 is required if the NAN service discovery frame does not include a resource constraint attribute.

Field 445: The HT/VHT capability field may indicate whether the device supports High Throughput (HT) or Very High Throughput (VHT) as defined by the IEEE 802.11 family of standards.

Field 450: The security field may indicate preferred security options for the device. Such security options may include robust security network (RSNE) or other security options (e.g., those defined in the 802.11 family of standards).

Field 455: The quality of service (QoS) field may indicate enhanced distributed channel access (EDCA) parameters, a transmit opportunity (TXOP) limit, QoS traffic delivery mechanism, etc.

Field 460: The low power field may indicate parameters for traffic indication operation, traffic indication window, or other operations that aid the device to achieve lower power operation.

Field 465: The multicast field may indicate multicast related parameters.

Field 470: The availability information field may include map control or further availability data. In an example, one or more of this data is in a bitmap data structure. These data may indicate available time slots (e.g., intervals, windows, etc.) for the device or channels for service delivery.

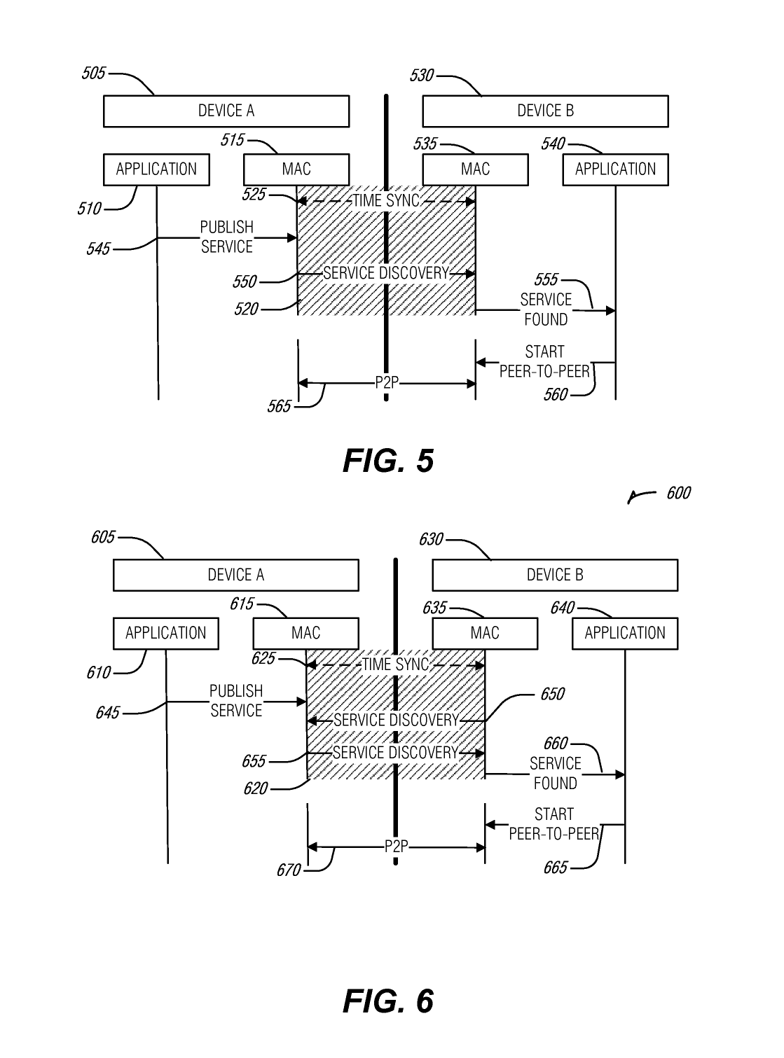

FIG. 5 is a swim-lane diagram of a method 500 for performing expedited robust peer-to-peer connection in a NAN environment, according to an embodiment. The illustrated structural components of the method include two devices, the device A 505 and the device B 530. The device A 505 includes an application 510 that provides a service and a MAC layer 515 involved in the NAN. The device B 530 includes an application 540 that wants to consume the service provided by the application 510, and a MAC layer 535 to participate in the NAN. The shaded region 520 represents the common window for NAN discovery.

As NAN entities, the devices A 505 and B 530 synchronize time 525 to implement the NAN discovery window 520. The application 510 publishes its service to a NAN facility in the device A 505. This publication is then constructed into the NAN service discovery frame discussed herein and broadcast to the NAN 520, and received by the device B 530. The Application 540 is notified that the service was found 555 and given access to the expedited robust connection data structure in the NAN service discovery frame. The application 540 uses the information in the expedited robust data structure to start 560 and establish a robust (e.g., peer-to-peer) connection 565 to the device A 505, to receive the service.

Another way to describe the operations of the method 500 is to say that the device B 530 is aware of the capability of both the device A 505, via the expedited robust connection data structure, and itself. Further, the device B 530 knows at what physical resources (e.g., channels) and times the device A 505 will accept the robust connection to deliver the service. Accordingly, the device B 530 uses the capabilities that match between the two devices, as well as the service availability information, to establish the robust connection without further negotiation. In an example, the device B 530 chooses the common capabilities with the highest performance metric (e.g., greatest speed, least power, greatest reliability, etc.)

FIG. 6 is a swim-lane diagram of a method 600 for performing expedited robust peer-to-peer connection in a NAN environment, according to an embodiment. The illustrated structural components of the method include two devices, the device A 605 and the device B 630. The device A 605 includes an application 610 that provides a service and a MAC layer 615 involved in the NAN. The device B 630 includes an application 640 that wants to consume the service provided by the application 610, and a MAC layer 635 to participate in the NAN. The shaded region 620 represents the common window for NAN discovery.

The operations of the method 600 largely conform to those of the method 500, except that the device B 630 is actively seeking the service via a NAN service discovery frame 650. After the time synchronization 625 and service publication 645. Because the device A 605 now has capability information about the device B 630, the device A 605 tailors the NAN service discovery frame to incorporate these abilities. Thus, capabilities not supported by the device B 630, but supported by the device A 605, are omitted from the NAN service discovery frame before it is broadcast 655. Now, as in the method 500, the Application 640 is notified that the service was found 660 and given access to the expedited robust connection data structure in the NAN service discovery frame. The application 640 uses the information in the expedited robust data structure to start 665 a robust (e.g., peer-to-peer) connection 670 to the device A 605, to receive the service.

The example embodiments discussed herein generally describe unicast service delivery mechanisms and constrain themselves to setting up the robust connection. In an example, the general principles herein may be applied to multicast robust connections. In this example, a service provider may broadcast a message, without data path setup, to request other NAN participants to transmit NAN service discovery frames for an identified service. The device may then intersect the contents of these NAN service discovery frames (such as described above with respect to FIG. 2 or 6) to produce an aggregate NAN service discovery frame to service consumers.

In an example, data path tear down (e.g., closing the robust connection) may be accomplished using NAN service discovery frames. For example, if the device B 630 does not receive additional NAN service discovery frames from the device A 605, then the device B 630 will shut down the data link for the robust connection. In an example, the roles may be reversed, whereby the service consumer, the device B 630, uses NAN service discovery frames to notify the device A 605 to keep the data link open. Thus, the absence of these frames will cause the device A 605 to shut down the data link. Predetermined timeouts based on these NAN service discovery frame events may be used to govern the correlation between the frames and data link tear down.

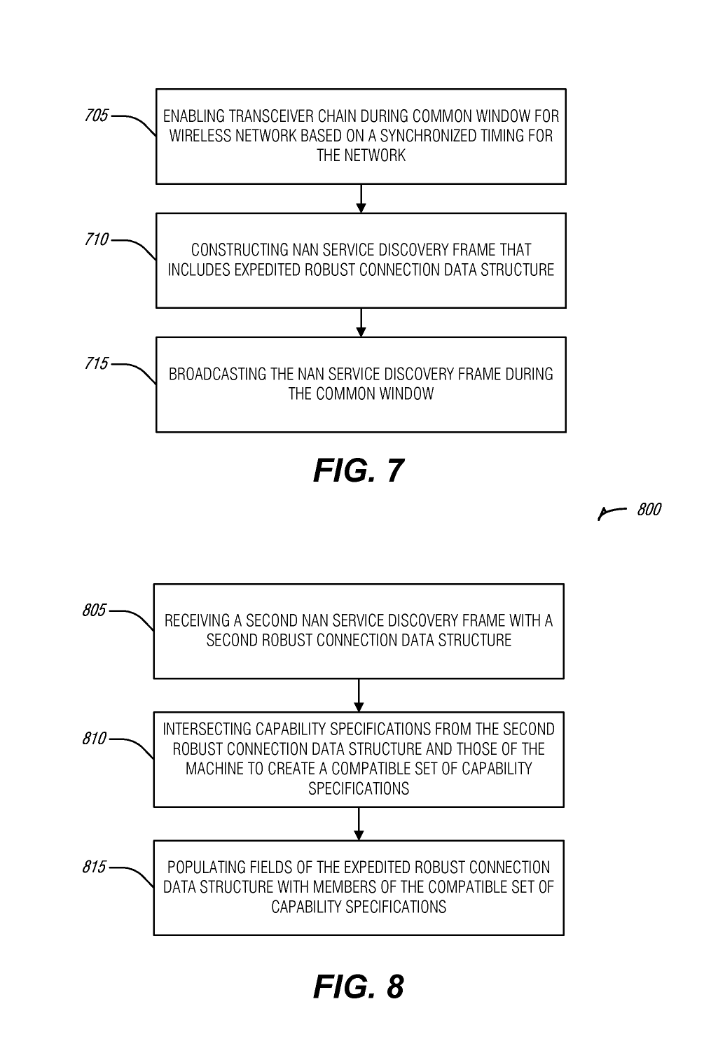

FIG. 7 illustrates a flow diagram of an example of a method for expedited robust peer-to-peer connection in a NAN environment, according to an embodiment. The operations of the method 700 are implemented in hardware, such as that described above with respect to FIG. 2, or below with respect to FIG. 10 (e.g., circuit sets).

At operation 705, a transceiver of a device is enabled during a common window for a wireless network based on a synchronized timing for the network.

At operation 710, a NAN service discovery frame for a service is constructed. The NAN service discovery frame includes an expedited robust connection data structure. The expedited robust connection data structure includes a request for a robust connection for the service and a service capability data structure. The service capability data structure includes a plurality of communications capabilities of the device that correspond to the service and the robust connection. In an example, the NAN service discovery frame, the expedited robust connection data structure, or the service capability data structure may include any or all of the elements and structure discussed above with respect to FIGS. 2-4.

At operation 715, the NAN service discovery frame is broadcast during the common window via the transceiver. In an example, the NAN service discovery frame is the only frame sent by the device with respect to the service, the robust connection, and the window excluding simple acknowledgments. In an example, the NAN service discovery frame is the only frame sent by the device in the window excluding simple acknowledgments.

FIG. 8 illustrates a flow diagram of an example of a method 800 for selecting capabilities of a service to include in a robust connection data structure, according to an embodiment. The operations of the method 800 are implemented in hardware, such as that described above with respect to FIG. 2, or below with respect to FIG. 10 (e.g., circuit sets). The method 800 may be combined with the method 700 to, for example, implement the operation 710.

At operation 805, a NAN service discovery frame is received at a device from a second device during a common window. The received NAN service discovery frame includes an expedited robust connection data structure.

At operation 810, the device intersects the capability specifications from the expedited robust connection data structure with its own capabilities to create a compatible set of capability specifications.

At operation 815, the device populates fields of its own expedited robust connection data structure with members of the compatible set of capability specifications.

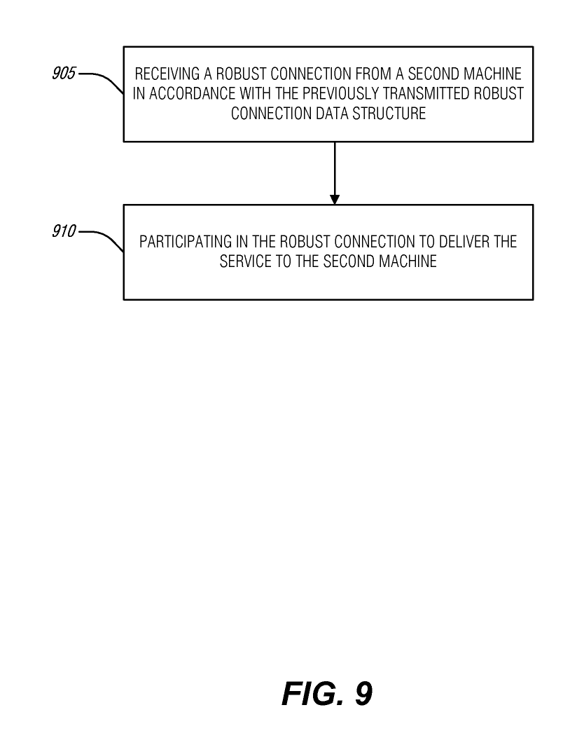

FIG. 9 illustrates a flow diagram of an example of a method 900 for communicating with a second machine using the robust connection after the transference of the robust connection data structure in a NAN service discovery frame, according to an embodiment. The operations of the method 900 are implemented in hardware, such as that described above with respect to FIG. 2, or below with respect to FIG. 10 (e.g., circuit sets). The method 900 may be combined with the method 700, after operation 715, to realize the expedited robust connection technique.

At operation 905, the device receives a robust connection from another device machine in accordance with a robust connection data structure sent during the common window in a NAN service discovery frame.

At operation 910, the device participates in the robust connection to deliver the service to the second machine. In an example, there is no further communications negations (e.g., channel, rate, symbol set, code book, security, etc.) involved in the device's participation in the robust connection. Accordingly, the entirety of the negotiated communications parameters are contained in the original NAN service discovery frame transmitted by the device.

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (or other distributed) network environment. As used herein, peer-to-peer referes to a data link directly between two devices (e.g., it is not a hub- and spoke topology). Accordingly, peer-to-peer networking is networking to a set of machines using peer-to-peer data links. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 on which is stored one or more sets of data structures or instructions 1024 (e.g., software) embodying or utilized by any one or more of the techniques or functions described herein.

The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### Additional Notes & Examples

Example 1 is an apparatus of a station (STA) for expedited robust peer-to-peer connection, the apparatus comprising: a service manager to construct a neighbor awareness networking (NAN) service discovery frame for a service, the NAN service discovery frame including an expedited robust connection data structure, the expedited robust connection data structure including: a request for a robust connection for the service; and a service capability data structure, the service capability data structure including a plurality of communications capabilities of the STA that correspond to the service and the robust connection; a transceiver to wireless communicate in accordance with an IEEE 802.11 family of standards; and a controller to: enable the transceiver during a common window for a wireless network based on a synchronized timing for the network; and control the transceiver to broadcast the NAN service discovery frame during the common window via the transceiver.

In Example 2, the subject matter of any one or more of Examples 1-1 may optionally include, wherein the NAN service discovery frame is the only frame sent by the STA with respect to the service, the robust connection, and the window excluding simple acknowledgments

In Example 3, the subject matter of any one or more of Examples 1-2 may optionally include, wherein the request for the robust connection is in at least one of a service descriptor attribute or a NAN connection capability attribute of the NAN service discovery frame.

In Example 4, the subject matter of any one or more of Examples 3-3 may optionally include, wherein the service capability data structure is a set of fields in the request for the robust connection.

In Example 5, the subject matter of Example 4 may optionally include, wherein the request for the robust connection includes: an attribute identification (ID) field indicating expedited robust connection capability; a length field that defines the size of additional fields; and a non-empty set of additional fields defined by starting at offsets the size of the length indicated in the length field and sized less than or equal to the length.

In Example 6, the subject matter of Example 5 may optionally include, wherein a field in the set of additional fields is a media access control (MAC) interface address for the service.

In Example 7, the subject matter of any one or more of Examples 5-6 may optionally include, wherein a field in the set of additional fields is a network protocol port for the service.

In Example 8, the subject matter of Example 7 may optionally include, wherein the network protocol conforms to the internet protocol version 6 (IPv6) standard.

In Example 9, the subject matter of any one or more of Examples 1-8 may optionally include, wherein the service capability data structure includes a capability bitmap field encoded to convey the capability of the service.

In Example 10, the subject matter of any one or more of Examples 1-9 may optionally include, wherein the service capability data structure includes a field for supported data rates for the robust connection.

In Example 11, the subject matter of Example 10 may optionally include, wherein the service capability data structure includes a country field.

In Example 12, the subject matter of Example 11 may optionally include, wherein the service capability data structure includes a field for operating class and supported channel.

In Example 13, the subject matter of Example 12 may optionally include, wherein the service capability data structure includes a field to indicate whether the STA supports High Throughput (HT) or Very High Throughput (VHT) as defined by the IEEE 802.11 family of standards.

In Example 14, the subject matter of Example 13 may optionally include, wherein the service capability data structure includes a security field that includes a set of security options supported by the service.

In Example 15, the subject matter of Example 14 may optionally include, wherein the security field includes mark for a subset of the set of security options to indicate preferred security options.

In Example 16, the subject matter of Example 15 may optionally include, wherein the service capability data structure includes a quality-of-service (QOS) field.

In Example 17, the subject matter of Example 16 may optionally include, wherein the service capability data structure includes a low-power field.

In Example 18, the subject matter of Example 17 may optionally include, wherein the service capability data structure includes a multicast field.

In Example 19, the subject matter of Example 18 may optionally include, wherein the service capability data structure includes an availability field to indicate at least one of available time slots for the robust connection, channels available for the robust connection, or further service discovery options.

In Example 20, the subject matter of Example 19 may optionally include, wherein one or more of the availability field information elements is a bitmap data structure.

In Example 21, the subject matter of any one or more of Examples 1-20 may optionally include, wherein the controller is further configured to: receive a second NAN service discovery frame from a second STA during the common window, the second NAN service discovery frame including a second expedited robust connection data structure; and wherein the services manager is further configured to: intersect capability specifications from the second expedited robust connection data structure with those of the STA to create a compatible set of capability specifications; and populate fields of the expedited robust connection data structure with members of the compatible set of capability specifications.

In Example 22, the subject matter of any one or more of Examples 1-21 may optionally include, wherein the controller is further configured to: receive a robust connection from a second STA in accordance with the robust connection data structure; and participate in the robust connection to deliver the service to the second STA.

Example 23 is at least one machine readable medium including instructions that, when executed by a STA, configure the STA to: enable a transceiver of the STA during a common window for a wireless network based on a synchronized timing for the network; construct a neighbor awareness networking (NAN) service discovery frame for a service, the NAN service discovery frame including an expedited robust connection data structure, the expedited robust connection data structure including: a request for a robust connection for the service; and a service capability data structure, the service capability data structure including a plurality of communications capabilities of the STA that correspond to the service and the robust connection; and broadcast the NAN service discovery frame during the common window via the transceiver.

In Example 24, the subject matter of Example 23 may optionally include, wherein the NAN service discovery frame is the only frame sent by the STA with respect to the service, the robust connection, and the window excluding simple acknowledgments.

In Example 25, the subject matter of any one or more of Examples 23-24 may optionally include, wherein the request for the robust connection is in at least one of a service descriptor attribute or a NAN connection capability attribute of the NAN service discovery frame.

In Example 26, the subject matter of Example 25 may optionally include, wherein the service capability data structure is a set of fields in the request for the robust connection.

In Example 27, the subject matter of Example 26 may optionally include, wherein the request the robust connection includes: an attribute identification (ID) field indicating expedited robust connection capability; a length field that defines the size of additional fields; and a non-empty set of additional fields defined by starting at offsets the size of the length indicated in the length field and sized less than or equal to the length.

In Example 28, the subject matter of Example 27 may optionally include, wherein a field in the set of additional fields is a media access control (MAC) interface address for the service.

In Example 29, the subject matter of any one or more of Examples 27-28 may optionally include, wherein a field in the set of additional fields is a network protocol port for the service.

In Example 30, the subject matter of Example 29 may optionally include, wherein the network protocol conforms to the internet protocol version 6 (IPv6) standard.

In Example 31, the subject matter of any one or more of Examples 23-30 may optionally include, wherein the service capability data structure includes a capability bitmap field encoded to convey the capability of the service.

In Example 32, the subject matter of any one or more of Examples 23-31 may optionally include, wherein the service capability data structure includes a field for supported data rates for the robust connection.

In Example 33, the subject matter of any one or more of Examples 23-32 may optionally include, wherein the service capability data structure includes a country field.

In Example 34, the subject matter of any one or more of Examples 23-33 may optionally include, wherein the service capability data structure includes a field for operating class and supported channel.

In Example 35, the subject matter of any one or more of Examples 23-34 may optionally include, wherein the service capability data structure includes a field to indicate whether the STA supports High Throughput (HT) or Very High Throughput (VHT) as defined by the IEEE 802.11 family of standards.

In Example 36, the subject matter of any one or more of Examples 23-35 may optionally include, wherein the service capability data structure includes a security field that includes a set of security options supported by the service.

In Example 37, the subject matter of Example 36 may optionally include, wherein the security field includes mark for a subset of the set of security options to indicate preferred security options.

In Example 38, the subject matter of any one or more of Examples 23-37 may optionally include, wherein the service capability data structure includes a quality-of-service (QOS) field.

In Example 39, the subject matter of any one or more of Examples 23-38 may optionally include, wherein the service capability data structure includes a low-power field.

In Example 40, the subject matter of any one or more of Examples 23-39 may optionally include, wherein the service capability data structure includes a multicast field.

In Example 41, the subject matter of any one or more of Examples 23-40 may optionally include, wherein the service capability data structure includes an availability field to indicate at least one of available time slots for the robust connection, channels available for the robust connection, or further service discovery options.

In Example 42, the subject matter of Example 41 may optionally include, wherein one or more of the availability field information is a bitmap data structure.

In Example 43, the subject matter of any one or more of Examples 23-42 may optionally include, wherein the STA is further configured to: receive a second NAN service discovery frame from a second STA during the common window, the second NAN service discovery frame including a second expedited robust connection data structure; intersect capability specifications from the second expedited robust connection data structure with those of the STA to create a compatible set of capability specifications; and populate fields of the expedited robust connection data structure with members of the compatible set of capability specifications.

In Example 44, the subject matter of any one or more of Examples 23-43 may optionally include, wherein the STA is further configured to: receive a robust connection from a second STA in accordance with the robust connection data structure; and participate in the robust connection to deliver the service to the second STA.

Example 45 is a method for expedited robust peer-to-peer connection, the method comprising: enabling a transceiver of the STA during a common window for a wireless network based on a synchronized timing for the network; constructing a neighbor awareness networking (NAN) service discovery frame for a service, the NAN service discovery frame including an expedited robust connection data structure, the expedited robust connection data structure including: a request for a robust connection for the service; and a service capability data structure, the service capability data structure including a plurality of communications capabilities of the STA that correspond to the service and the robust connection; and broadcasting the NAN service discovery frame during the common window via the transceiver.

In Example 46, the subject matter of Example 45 may optionally include, wherein the NAN service discovery frame is the only frame sent by the STA with respect to the service, the robust connection, and the window excluding simple acknowledgments.

In Example 47, the subject matter of any one or more of Examples 45-46 may optionally include, wherein the request for the robust connection is in at least one of a service descriptor attribute or a NAN connection capability attribute of the NAN service discovery frame.

In Example 48, the subject matter of Example 47 may optionally include, wherein the service capability data structure is a set of fields in the request for the robust connection.

In Example 49, the subject matter of Example 48 may optionally include, wherein the request the robust connection includes: an attribute identification (ID) field indicating expedited robust connection capability; a length field that defines the size of additional fields; and a non-empty set of additional fields defined by starting at offsets the size of the length indicated in the length field and sized less than or equal to the length.

In Example 50, the subject matter of Example 49 may optionally include, wherein a field in the set of additional fields is a media access control (MAC) interface address for the service.

In Example 51, the subject matter of any one or more of Examples 49-50 may optionally include, wherein a field in the set of additional fields is a network protocol port for the service.

In Example 52, the subject matter of Example 51 may optionally include, wherein the network protocol conforms to the internet protocol version 6 (IPv6) standard.

In Example 53, the subject matter of any one or more of Examples 45-52 may optionally include, wherein the service capability data structure includes a capability bitmap field encoded to convey the capability of the service.

In Example 54, the subject matter of any one or more of Examples 45-53 may optionally include, wherein the service capability data structure includes a field for supported data rates for the robust connection.

In Example 55, the subject matter of any one or more of Examples 45-54 may optionally include, wherein the service capability data structure includes a country field.

In Example 56, the subject matter of any one or more of Examples 45-55 may optionally include, wherein the service capability data structure includes a field for operating class and supported channel.

In Example 57, the subject matter of any one or more of Examples 45-56 may optionally include, wherein the service capability data structure includes a field indicating whether the STA supports High Throughput (HT) or Very High Throughput (VHT) as defined by the IEEE 802.11 family of standards.

In Example 58, the subject matter of any one or more of Examples 45-57 may optionally include, wherein the service capability data structure includes a security field that includes a set of security options supported by the service.

In Example 59, the subject matter of Example 58 may optionally include, wherein the security field includes mark for a subset of the set of security options indicating preferred security options.

In Example 60, the subject matter of any one or more of Examples 45-59 may optionally include, wherein the service capability data structure includes a quality-of-service (QOS) field.

In Example 61, the subject matter of any one or more of Examples 45-60 may optionally include, wherein the service capability data structure includes a low-power field.

In Example 62, the subject matter of any one or more of Examples 45-61 may optionally include, wherein the service capability data structure includes a multicast field.

In Example 63, the subject matter of any one or more of Examples 45-62 may optionally include, wherein the service capability data structure includes an availability field including at least one of available time slots for the robust connection, channels available for the robust connection, or further service discovery options.

In Example 64, the subject matter of Example 63 may optionally include, wherein one or more of the availability field information is a bitmap data structure.

In Example 65, the subject matter of any one or more of Examples 45-64 may optionally include, comprising: receiving a second NAN service discovery frame from a second STA during the common window, the second NAN service discovery frame including a second expedited robust connection data structure; intersecting capability specifications from the second expedited robust connection data structure with those of the STA to create a compatible set of capability specifications; and populating fields of the expedited robust connection data structure with members of the compatible set of capability specifications.

In Example 66, the subject matter of any one or more of Examples 45-65 may optionally include, comprising: receiving a robust connection from a second STA in accordance with the robust connection data structure; and participating in the robust connection to deliver the service to the second STA.

Example 67 is a device for expedited robust peer-to-peer connection, the device comprising: means for enabling a transceiver of the STA during a common window for a wireless network based on a synchronized timing for the network; means for constructing a neighbor awareness networking (NAN) service discovery frame for a service, the NAN service discovery frame including an expedited robust connection data structure, the expedited robust connection data structure including: a request for a robust connection for the service; and a service capability data structure, the service capability data structure including a plurality of communications capabilities of the STA that correspond to the service and the robust connection; and means for broadcasting the NAN service discovery frame during the common window via the transceiver.

In Example 68, the subject matter of Example 67 may optionally include, wherein the NAN service discovery frame is the only frame sent by the STA with respect to the service, the robust connection, and the window excluding simple acknowledgments.

In Example 69, the subject matter of any one or more of Examples 67-68 may optionally include, wherein the request for the robust connection is in at least one of a service descriptor attribute or a NAN connection capability attribute of the NAN service discovery frame.

In Example 70, the subject matter of Example 69 may optionally include, wherein the service capability data structure is a set of fields in the request for the robust connection.

In Example 71, the subject matter of Example 70 may optionally include, wherein the request the robust connection includes: an attribute identification (ID) field indicating expedited robust connection capability; a length field that defines the size of additional fields; and a non-empty set of additional fields defined by starting at offsets the size of the length indicated in the length field and sized less than or equal to the length.

In Example 72, the subject matter of Example 71 may optionally include, wherein a field in the set of additional fields is a media access control (MAC) interface address for the service.

In Example 73, the subject matter of any one or more of Examples 71-72 may optionally include, wherein a field in the set of additional fields is a network protocol port for the service.

In Example 74, the subject matter of Example 73 may optionally include, wherein the network protocol conforms to the internet protocol version 6 (IPv6) standard.

In Example 75, the subject matter of any one or more of Examples 67-74 may optionally include, wherein the service capability data structure includes a capability bitmap field encoded to convey the capability of the service.

In Example 76, the subject matter of any one or more of Examples 67-75 may optionally include, wherein the service capability data structure includes a field for supported data rates for the robust connection.

In Example 77, the subject matter of any one or more of Examples 67-76 may optionally include, wherein the service capability data structure includes a country field.

In Example 78, the subject matter of any one or more of Examples 67-77 may optionally include, wherein the service capability data structure includes a field for operating class and supported channel.

In Example 79, the subject matter of any one or more of Examples 67-78 may optionally include, wherein the service capability data structure includes a field indicating whether the STA supports High Throughput (HT) or Very High Throughput (VHT) as defined by the IEEE 802.11 family of standards.

In Example 80, the subject matter of any one or more of Examples 67-79 may optionally include, wherein the service capability data structure includes a security field that includes a set of security options supported by the service.

In Example 81, the subject matter of Example 80 may optionally include, wherein the security field includes mark for a subset of the set of security options indicating preferred security options.

In Example 82, the subject matter of any one or more of Examples 67-81 may optionally include, wherein the service capability data structure includes a quality-of-service (QOS) field.

In Example 83, the subject matter of any one or more of Examples 67-82 may optionally include, wherein the service capability data structure includes a low-power field.

In Example 84, the subject matter of any one or more of Examples 67-83 may optionally include, wherein the service capability data structure includes a multicast field.

In Example 85, the subject matter of any one or more of Examples 67-84 may optionally include, wherein the service capability data structure includes an availability field including at least one of available time slots for the robust connection, channels available for the robust connection, or further service discovery options.

In Example 86, the subject matter of Example 85 may optionally include, wherein one or more of the availability field information is a bitmap data structure.

In Example 87, the subject matter of any one or more of Examples 67-86 may optionally include, comprising: means for receiving a second NAN service discovery frame from a second STA during the common window, the second NAN service discovery frame including a second expedited robust connection data structure; means for intersecting capability specifications from the second expedited robust connection data structure with those of the STA to create a compatible set of capability specifications; and means for populating fields of the expedited robust connection data structure with members of the compatible set of capability specifications.

In Example 88, the subject matter of any one or more of Examples 67-87 may optionally include, comprising: means for receiving a robust connection from a second STA in accordance with the robust connection data structure; and means for participating in the robust connection to deliver the service to the second STA.

Example 89 is an apparatus of a station (STA) for expedited robust peer-to-peer connection, the apparatus comprising: a neighborhood awareness network (NAN) controller to: enable a transceiver during a common window for a wireless network based on synchronized timing for the network; and obtain a NAN service discovery frame from a member of the wireless network for a service, the NAN service discovery frame including a robust connection data structure; and a robust connection controller to: obtain elements of the robust connection data structure from the obtained NAN service discovery frame; and establish a robust connection using the elements to the service.

In Example 90, the subject matter of Example 89 may optionally include, wherein the STA has no communication with the member of the wireless network between the receipt of the NAN service discovery frame and the establishment of the robust connection.

In Example 91, the subject matter of any one or more of Examples 89-90 may optionally include, wherein to obtain elements the robust connection data structure includes parsing a request for a robust connection from the robust connection data structure and using one or more elements from the request for the robust connection to connect to the service.

In Example 92, the subject matter of Example 91 may optionally include, wherein to connect to the service includes selecting from a plurality of connection options, the plurality of connection options being the intersection of a set of communications capabilities of the STA and the member of the wireless network as communicated in a service capability data structure in the NAN service discovery frame.

In Example 93, the subject matter of Example 92 may optionally include, wherein the service capability data structure is a set of field in the request for the robust connection.

Example 94 is at least one machine readable medium including instructions for expedited robust peer-to-peer connection that, when executed by a station (STA), cause the STA to: enable a transceiver during a common window for a wireless network based on synchronized timing for the network; obtain a NAN service discovery frame from a member of the wireless network for a service, the NAN service discovery frame including a robust connection data structure; and obtain elements of the robust connection data structure from the obtained NAN service discovery frame; and establish a robust connection using the elements to the service.

In Example 95, the subject matter of Example 94 may optionally include, wherein the STA has no communication with the member of the wireless network between the receipt of the NAN service discovery frame and the establishment of the robust connection.

In Example 96, the subject matter of any one or more of Examples 94-95 may optionally include, wherein to obtain elements the robust connection data structure includes parsing a request for a robust connection from the robust connection data structure and using one or more elements from the request for the robust connection to connect to the service.

In Example 97, the subject matter of Example 96 may optionally include, wherein to connect to the service includes selecting from a plurality of connection options, the plurality of connection options being the intersection of a set of communications capabilities of the STA and the member of the wireless network as communicated in a service capability data structure in the NAN service discovery frame.

In Example 98, the subject matter of Example 97 may optionally include, wherein the service capability data structure is a set of field in the request for the robust connection.

Example 99 is a method for expedited robust peer-to-peer connection the method comprising: enabling a transceiver during a common window for a wireless network based on synchronized timing for the network; obtaining a NAN service discovery frame from a member of the wireless network for a service, the NAN service discovery frame including a robust connection data structure; obtaining elements of the robust connection data structure from the obtained NAN service discovery frame; and establishing a robust connection using the elements to the service.

In Example 100, the subject matter of Example 99 may optionally include, wherein the STA has no communication with the member of the wireless network between the receipt of the NAN service discovery frame and the establishment of the robust connection.

In Example 101, the subject matter of any one or more of Examples 99-100 may optionally include, wherein obtaining elements of the robust connection data structure includes parsing a request for a robust connection from the robust connection data structure and using one or more elements from the request for the robust connection to connect to the service.

In Example 102, the subject matter of Example 101 may optionally include, wherein connecting to the service includes selecting from a plurality of connection options, the plurality of connection options being the intersection of a set of communications capabilities of the STA and the member of the wireless network as communicated in a service capability data structure in the NAN service discovery frame.

In Example 103, the subject matter of Example 102 may optionally include, wherein the service capability data structure is a set of field in the request for the robust connection.

Example 104 is a system for expedited robust peer-to-peer connection the method comprising: means for enabling a transceiver during a common window for a wireless network based on synchronized timing for the network; means for obtaining a NAN service discovery frame from a member of the wireless network for a service, the NAN service discovery frame including a robust connection data structure; means for obtaining elements of the robust connection data structure from the obtained NAN service discovery frame; and means for establishing a robust connection using the elements to the service.

In Example 105, the subject matter of Example 104 may optionally include, wherein the STA has no communication with the member of the wireless network between the receipt of the NAN service discovery frame and the establishment of the robust connection.

In Example 106, the subject matter of any one or more of Examples 104-105 may optionally include, wherein the means for obtaining elements of the robust connection data structure includes means for parsing a request for a robust connection from the robust connection data structure and using one or more elements from the request for the robust connection to connect to the service.

In Example 107, the subject matter of Example 106 may optionally include, wherein the means for connecting to the service includes means for selecting from a plurality of connection options, the plurality of connection options being the intersection of a set of communications capabilities of the STA and the member of the wireless network as communicated in a service capability data structure in the NAN service discovery frame.

In Example 108, the subject matter of Example 107 may optionally include, wherein the service capability data structure is a set of field in the request for the robust connection.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An apparatus of a station (STA) for expedited robust peer-to-peer connection, the apparatus comprising:
a service manager to construct a neighbor awareness networking (NAN) service discovery frame for a service, the NAN service discovery frame including an expedited robust connection data structure, the expedited robust connection data structure including:
a request for a robust connection for the service; and
a service capability data structure, the service capability data structure including a plurality of communications capabilities of the STA that correspond to the service and the robust connection;
a transceiver to wireless communicate in accordance with an IEEE 802.11 family of standards; and
a controller to:
enable the transceiver during a common window for a wireless network based on a synchronized timing for the network; and
control the transceiver to broadcast the NAN service discovery frame during the common window via the transceiver.

2. The apparatus of claim 1, wherein the NAN service discovery frame is the only frame sent by the STA with respect to the service, the robust connection, and the window excluding simple acknowledgments.

3. The apparatus of claim 1, wherein the request for the robust connection is in at least one of a service descriptor attribute or a NAN connection capability attribute of the NAN service discovery frame.

4. The apparatus of claim 3, wherein the service capability data structure is a set of fields in the request for the robust connection.

5. The apparatus of claim 4, wherein the request for the robust connection includes:
an attribute identification (ID) field indicating expedited robust connection capability;
a length field that defines the size of additional fields; and
a non-empty set of additional fields defined by starting at offsets the size of the length indicated in the length field and sized less than or equal to the length.

6. The apparatus of claim 1, wherein the controller is further configured to:
receive a second NAN service discovery frame from a second STA during the common window, the second NAN service discovery frame including a second expedited robust connection data structure; and
wherein the services manager is further configured to:
intersect capability specifications from the second expedited robust connection data structure with those of the STA to create a compatible set of capability specifications; and
populate fields of the expedited robust connection data structure with members of the compatible set of capability specifications.

7. The apparatus of claim 1, wherein the controller is further configured to:
receive a robust connection from a second STA in accordance with the robust connection data structure; and
participate in the robust connection to deliver the service to the second STA.

8. At least one machine readable medium including instructions that, when executed by a STA, configure the STA to:
enable a transceiver of the STA during a common window for a wireless network based on a synchronized timing for the network;
construct a neighbor awareness networking (NAN) service discovery frame for a service, the NAN service discovery frame including an expedited robust connection data structure, the expedited robust connection data structure including:
a request for a robust connection for the service; and
a service capability data structure, the service capability data structure including a plurality of communications capabilities of the STA that correspond to the service and the robust connection; and
broadcast the NAN service discovery frame during the common window via the transceiver.

9. The at least one machine readable media of claim 8, wherein the NAN service discovery frame is the only frame sent by the STA with respect to the service, the robust connection, and the window excluding simple acknowledgments.

10. The at least one machine readable media of claim 8, wherein the request for the robust connection is in at least one of a service descriptor attribute or a NAN connection capability attribute of the NAN service discovery frame.

11. The at least one machine readable media of claim 10, wherein the service capability data structure is a set of fields in the request for the robust connection.

12. The at least one machine readable media of claim 11, wherein the request the robust connection includes:
an attribute identification (ID) field indicating expedited robust connection capability;
a length field that defines the size of additional fields; and
a non-empty set of additional fields defined by starting at offsets the size of the length indicated in the length field and sized less than or equal to the length.

13. The at least one machine readable media of claim 8, wherein the STA is further configured to:
receive a second NAN service discovery frame from a second STA during the common window, the second NAN service discovery frame including a second expedited robust connection data structure;
intersect capability specifications from the second expedited robust connection data structure with those of the STA to create a compatible set of capability specifications; and
populate fields of the expedited robust connection data structure with members of the compatible set of capability specifications.

14. The at least one machine readable media of claim 8, wherein the STA is further configured to:
receive a robust connection from a second STA in accordance with the robust connection data structure; and
participate in the robust connection to deliver the service to the second STA.

15. A method for expedited robust peer-to-peer connection, the method comprising:
enabling a transceiver of the STA during a common window for a wireless network based on a synchronized timing for the network;
constructing a neighbor awareness networking (NAN) service discovery frame for a service, the NAN service discovery frame including an expedited robust connection data structure, the expedited robust connection data structure including:
a request for a robust connection for the service; and
a service capability data structure, the service capability data structure including a plurality of communications capabilities of the STA that correspond to the service and the robust connection; and
broadcasting the NAN service discovery frame during the common window via the transceiver.

16. The method of claim 15, wherein the NAN service discovery frame is the only frame sent by the STA with respect to the service, the robust connection, and the window excluding simple acknowledgments.

17. The method of claim 15, wherein the request for the robust connection is in at least one of a service descriptor attribute or a NAN connection capability attribute of the NAN service discovery frame.

18. The method of claim 17, wherein the service capability data structure is a set of fields in the request for the robust connection.

19. The method of claim 18, wherein the request the robust connection includes:
an attribute identification (ID) field indicating expedited robust connection capability;
a length field that defines the size of additional fields; and
a non-empty set of additional fields defined by starting at offsets the size of the length indicated in the length field and sized less than or equal to the length.

20. The method of claim 15, comprising:
receiving a robust connection from a second STA in accordance with the robust connection data structure; and
participating in the robust connection to deliver the service to the second STA.
